(19) United States
(12) Patent Application Publication
(10) Pub. No.: US 2005/0094030 A1
(43) Pub. Date: May 5, 2005

(54) Method and/or circuitry for video frame rate and/or size conversion

(75) Inventor: Herve Brelay, San Jose, CA (US)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 10/700,196

(22) Filed: Nov. 3, 2003

(51) Int. Cl. H04N 11/20

(52) U.S. Cl. 348/441; 348/443

(57) ABSTRACT

An apparatus comprising a de-interlacer circuit, a rate converter circuit and a synchronization circuit. The de-interlacer circuit may be configured to generate a first progressive signal having a first rate in response to an interlaced signal. The rate converter circuit may be configured to generate a second progressive signal having a second rate in response to the first progressive signal. The synchronization circuit may be configured to generate an output video signal synchronized with an output audio signal in response to an input audio signal and the second progressive signal.

### FIELD OF THE INVENTION

The present invention relates to video processing generally and, more particularly, to a method and/or circuitry for implementing video frame rate and/or size conversion.

### BACKGROUND OF THE INVENTION

Conventional approaches used to implement video frame rate conversion perform field/frame decisions for filtering and picture drop/repeat. Conventional solutions typically use extra memory to run an extra software pass which uses extra CPU cycles.

It would be desirable to implement a method and/or circuit for video frame conversion that does not use extra CPU processing cycles.

### SUMMARY OF THE INVENTION

One aspect of the present invention concerns an apparatus comprising a de-interlacer circuit, a rate converter circuit and a synchronization circuit. The de-interlacer circuit may be configured to generate a first progressive signal having a first rate in response to an interlaced signal. The rate converter circuit may be configured to generate a second progressive signal having a second rate in response to the first progressive signal. The synchronization circuit may be configured to generate an output video signal synchronized with an output audio signal in response to an input audio signal and the second progressive signal.

Another aspect of the present invention concerns a method for rate conversion of a video signal comprising the steps of (A) converting an interlaced video signal to a first progressive video signal having a first rate, (B) generating a second video signal having a second rate in response to the first video signal and (C) synchronizing the second video signal to an input audio signal.

The objects, features and advantages of the present invention include providing method and/or circuitry for video frame rate and/or size conversion that may (i) remove complexity of a video field based mechanism which needs vertical phase shifting and field/frame consideration for vertical resizing, (ii) provide the best solution for smoothness in interlaced video using a drop/repeat mechanism, (iii) provide a simple frame-based vertical filtering that avoids complex decisions, (iv) be easily be implemented in hardware (VLSI) (e.g., a cost effective solution), and/or (v) provide a conversion from 525 lines at 60 Hz to 625 lines at 50 Hz (or vice versa).

### BRIEF DESCRIPTION OF THE DRAWINGS

These and other objects, features and advantages of the present invention will be apparent from the following detailed description and the appended claims and drawings in which:

FIG. 1 is a block diagram illustrating video conversion;

FIG. 2 is a block diagram illustrating video conversion;

FIG. 3 is a block diagram of a video frame rate converter and vertical scaler;

FIG. 4 is a diagram illustrating an example where a frame is dropped;

FIG. 5 is a diagram illustrating an example illustrating where a video field is dropped;

FIG. 6 is a block diagram illustrating an example of progressive dropping before re-interlacing; and

FIG. 7 is a diagram of a series of fields illustrating an example of progressive dropping before re-interlacing.

### DETAILED DESCRIPTION OF THE PREFERRED EMBODIMENTS

In a video processing system, each picture may comprise a complete frame of video (e.g., a frame picture) or one of two interlaced fields from an interlaced source (e.g., a field picture). The field picture generally does not have any blank lines between the active lines of pixels. For example, if the field picture is viewed on a normal display, the field picture would appear short and fat. For interlaced sequences, the two fields may be encoded together as a frame picture. Alternatively, the two fields may be encoded separately as two field pictures. Both frame pictures and field pictures may be used together in a single interlaced sequence. High detail and limited motion generally favors frame picture encoding. In general, field pictures occur in pairs (e.g., top/bottom, odd/even, field1/field2). The output of a decoding process for an interlaced sequence is generally a series of reconstructed fields. For progressive scanned sequences, all pictures in the sequence are frame pictures. The output of a decoding process for a progressive sequence is generally a series of reconstructed frames.

The present invention may be used to simplify video frame rate conversion. For example, the present invention may be used to convert a 525 line/60 Hz signal to a 625 line/50 Hz signal (and vice versa). However, other size and/or rate conversions may be implemented to meet the design criteria of a particular implementation. Furthermore, rate conversion may be implemented along with (or separately from) a size conversion. The present invention may use de-interlacing technology already performed on the bitstream to simplify the rate conversion process. By using de-interlacing technology that is already implemented, additional processing may be minimized.

The present invention may provide a method and/or circuit for implementing video format conversion prior to the display of a digital video signal. The purpose is to present a simple and unique method for any video format conversion leading to a high quality picture (e.g., flicker free, artifact free, etc.) with an easy hardware implementation.

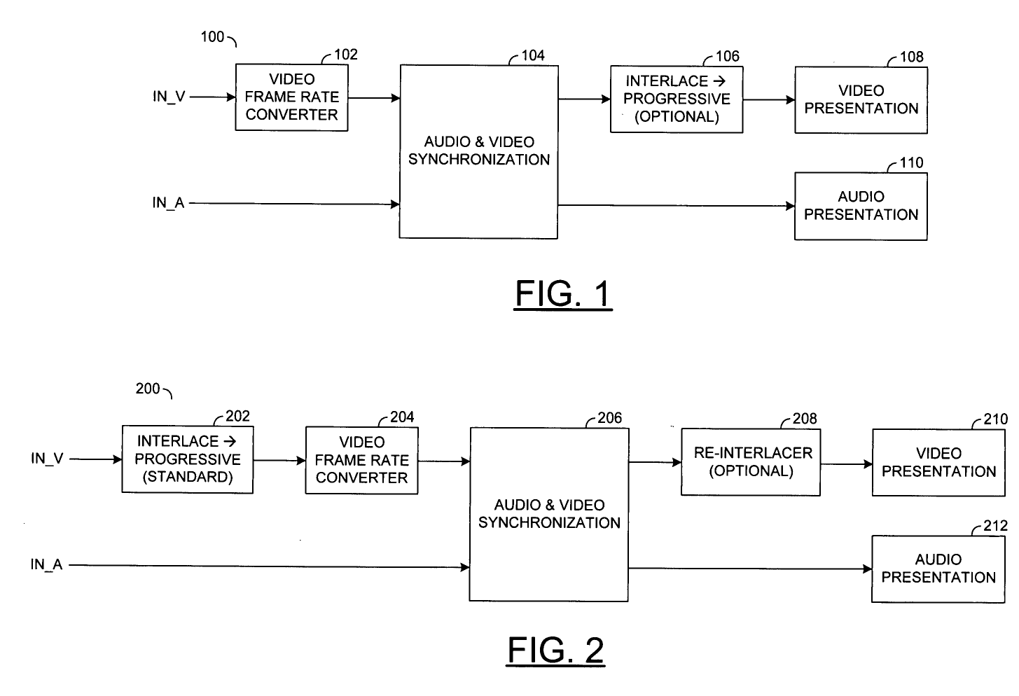

Referring to FIG. 1, a circuit 100 is shown implementing an audio/video presentation system. The circuit 100 generally comprises a video frame rate converter block (or circuit) 102, an audio and video synchronization block (or circuit) 104, an interlaced to progressive block (or circuit) 106, a video presentation block (or circuit) 108 and an audio presentation block (or circuit) 110.

The video frame rate converter circuit 102 may be used to convert a particular video input frame rate (e.g., 25 Hz, 24 Hz, 30 Hz . . . ) into a specific video frame rate intended for a particular viewing device (e.g., 25 Hz like PAL devices or 30 Hz for NTSC devices). The audio and video synchronization circuit 104 may be used to synchronize video and audio samples to a particular clock in order to ensure “lip-sync” during presentation by the audio presentation circuit 110 and the video presentation circuit 108. The video presentation circuit 108 may be implemented as a video monitor or other display device. The audio presentation circuit 110 may be implemented as a speaker or other device. The interlaced to progressive circuit 106 may be used to transform interlaced frames into progressive frames at double the rate of the interlaced frames. The circuit 106 doubles the number of lines presented each clock cycle. An example implementation of the interlaced to progressive circuit 106 may be the TrueScan Pro technology (e.g., DMN 8600) available from LSI Logic Corporation, Milpitas, Calif.

Referring to FIG. 2, a circuit 200 is shown illustrating a format conversion system. The circuit 200 generally comprises an interlaced to progressive conversion block (or circuit) 202, a video frame rate converter block (or circuit) 204, an audio and video synchronization block (or circuit) 206, a re-interlacer block (or circuit) 208, a video presentation block (or circuit) 210, and an audio presentation block (or circuit) 212. The re-interlacer circuit 208 may be used if an interlaced signal is desirable for a particular display device. However, the re-interlacer circuit 208 may not be needed in all design implementations. The video presentation circuit 210 may be a video monitor or other display device. The audio presentation circuit 212 may be implemented as a speaker or other device.

The interlaced to progressive circuit 202 is shown implemented prior the video frame rate conversion circuit 204 and the audio/video synchronization circuit 206. The circuit 200 uses the output of the interlaced to progressive converter circuit 202 to perform the frame rate conversion. The interlaced to progressive converter circuit 202 generally presents a progressive signal comprising a series of frames in response to an interlaced signal comprising a series of fields. In general, two fields make up each frame with an interlaced signal, where every second field is presented on every second clock cycle. In a progressive signal a full frame is presented on every clock cycle.

The re-interlacer circuit 208 is shown as an optional component that is used in case the video presentation 210 is done in interlaced format (e.g., NTSC or PAL). The re-interlacer circuit 208 may be used to extract half the lines of each input frame, typically used in all TV scanning equipment.

The frame rate converter block 204 may be implemented in the progressive domain. The frame rate converter block 204 repeats or drops a frame based on the timestamp of the incoming frames and the selected video output frame rate. The frame rate converter block 204 may also vertically resize each frame to the desired output format (e.g., 480 input lines from NTSC source material may be resized to 576 output lines for PAL format display or vice-versa).

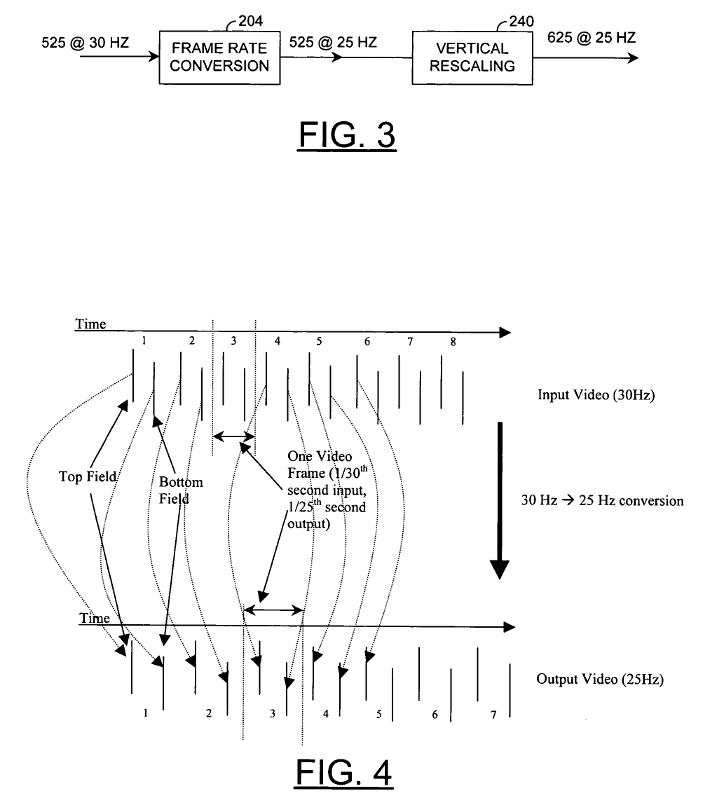

Referring to FIG. 3, a more detailed diagram of the video frame rate converter circuit 204 along with a vertical resealing circuit 240 is shown. The video frame rate converter circuit 204 implements a process based on the audio video synchronization block 206 to decide to drop/repeat an input frame. The frame rate converter circuit 204 generally (i) receives incoming progressive pictures with a timestamp, (ii) checks (or compares) the timestamp value to a clock running at the video output rate, (iii) repeats the previous incoming progressive frame if the input is running early or (iv) drops the incoming progressive frame and outputs the next incoming progressive frame if the input is running late. The frame rate converter circuit 204 also resizes the progressive input picture to the appropriate progressive output picture for display (if necessary). The frame rate conversion circuit 204 does not create samples or frames, but rather repeats/drops input samples (frames or fields) to adjust to the output frame rate.

Referring to FIG. 4, an example of video frame dropping is shown. In this example, one full video frame is dropped from the input signal. In order to create a 25 Hz signal from a 30 Hz signal, one video frame is normally dropped every six input video frames (i.e., 6 input frames become 5 output frames). The input video frames are shown labeled 1-8 above each pair of fields. The output video frames are shown 1-7 below each pair of fields. By dropping a full frame (i) each top field on the input remains a top field in the output and (ii) each bottom field on the input remains a bottom field in the output. Keeping field positioning eliminates (or reduces) up-down movement since the spatial position of each field remains fixed. When a full video input frame (e.g., 1/30^{th} of a second) is dropped, a non-smooth motion (or jerkiness) may result.

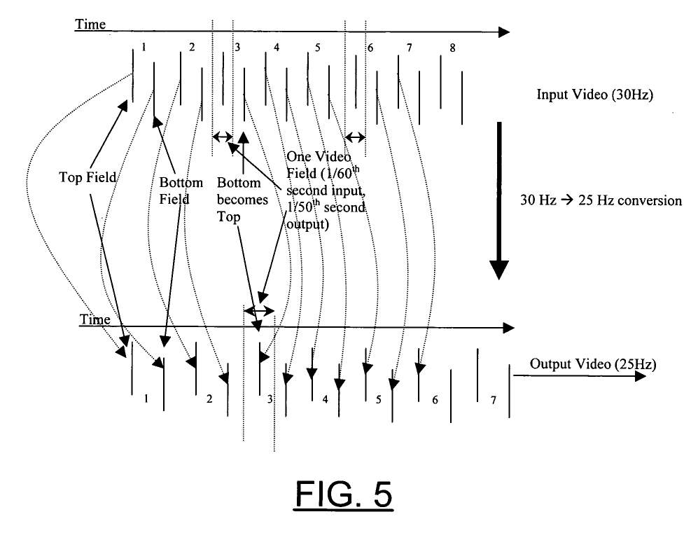

Referring to FIG. 5, an example of video field dropping is shown. In this example, one video field is dropped from the input signal. In order to create a 25 Hz signal from a 30 Hz signal, one video field is generally be dropped every six input video fields (i.e., 6 input fields become 5 output fields). The input video frames are shown labeled 1-8 above each pair of fields. The output video frames are shown labeled 1-7 below each pair of fields. Only one video field time (e.g., 1/60^{th} of a second) is dropped, minimizing the jerkiness issue. Such an implementation provides the best results for smoothness. However, after dropping one field, the top fields become the bottom fields and the bottom fields become the top fields. Because the fields are presented at a different spatial position, the fields need to be phase-shifted to avoid heavy up-down movement. Because of such filtering, blurriness may occur. The example of FIG. 5 provides improved smoothness, but at the expense of picture quality.

Once fields or frames are dropped to adjust the frame rate, a vertical resealing circuit resizes the frames to match the output vertical size. The nature of incoming video may have been shot with video equipment (e.g., interlaced sampling, each field created at different time) or with movie equipment and transcribed to video (e.g., both input fields are scanned from the same original picture). Using a frame-based filtering on video material creates a known artifact called “combing noise”. For video material, each field needs to be resized independently (field-based filtering). Using field-based filtering on movie material degrades the picture quality and generates blurriness, so frame-based filtering should be used for movie material. As a result, special handling for field/frame filtering decision needs to happen when performing vertical resizing.

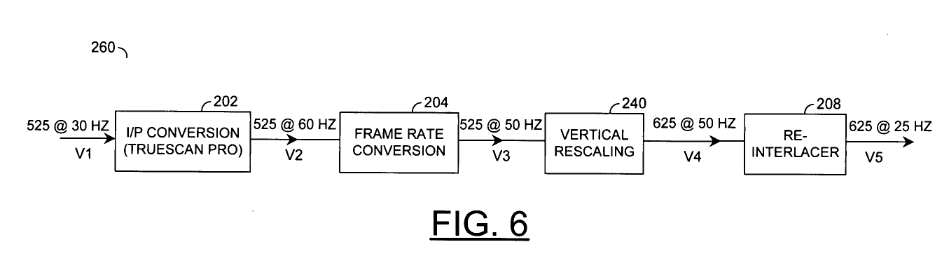

Referring to FIG. 6, an example of a system 260 illustrating progressive dropping before re-interlacing is shown. The system comprises the conversion circuit 202, the frame rate conversion circuit 204, a vertical resealing circuit 240 and the re-interlace circuit 208. By using the de-interlacing circuit 202, a progressive video signal (e.g., V2) is created in response to an interlaced video signal (e.g., V1). By converting to the progressive signal V2 before further processing and/or conversion, the concept of top/bottom fields is not relevant for additional processing. Rather, the progressive frames of the signal V2 are each positioned at a field-time interval (e.g., every 1/60^{th} of a second). A frame rate conversion circuit 204 drops one progressive frame every six input frames, creating a progressive output signal (e.g., V3) at the desired rate (e.g., 50 Hz), with smooth motion. Each output frame of the signal V3 is progressive (e.g., having 525 lines operating at 50 Hz). The vertical rescaler 240 generates a signal (e.g., V4) having, for example, 625 lines operating at 50 Hz.

The vertical rescaler circuit 240 only needs to perform progressive or frame-based filtering to adjust the size and does not need to perform complex field/frame decisions. The re-interlacer circuit 208 generates a signal (e.g., V5) having, for example, 625 lines operating at 25 Hz. The re-interlacer circuit 208 extracts the top or bottom lines of each incoming frame to create an interlaced result in a format presentable by an interlaced video display. The particular resolutions (e.g., 525 lines, 625 lines, etc.) and the particular operating frequencies (e.g., 25 Hz, 30 Hz, 50 Hz, 60 Hz, etc.) may be modified to meet the design criteria of a particular implementation.

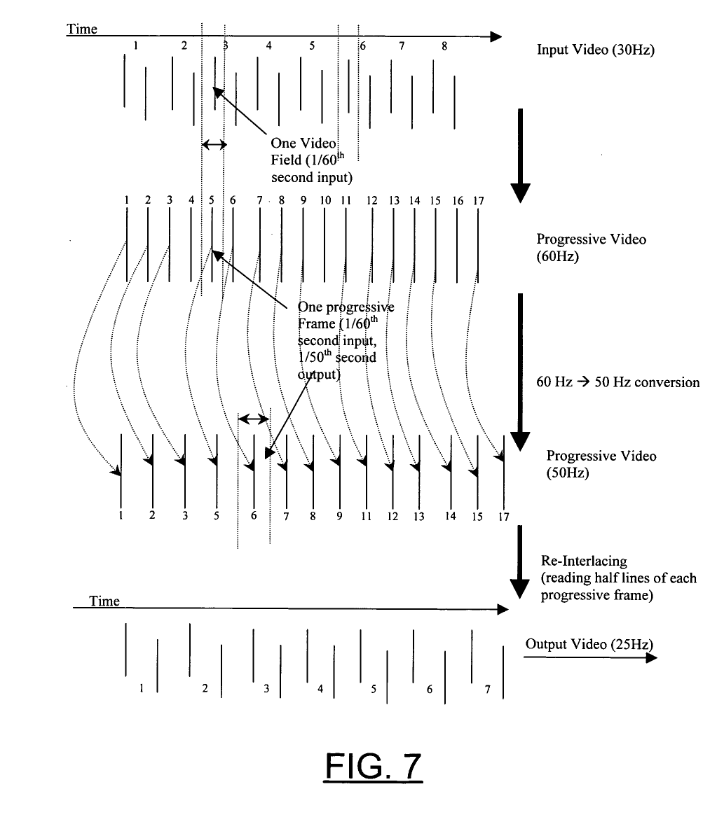

Referring to FIG. 7, a diagram of a number of frames illustrating progressive frame dropping before re-interlacing is shown. An input signal is shown as a series of interlaced frames labeled 1-8. The input signal is shown as a 30 Hz signal. The input signal is converted to a progressive signal operating at 60 Hz. The individual progressive frames are labeled 1-17. Next, a conversion from 60 Hz to 50 Hz is shown. The fourth field is normally dropped. For example, the order of the progressive video signal operating at 50 Hz is frame 1, 2, 3, 5, 6, 7, 8, 9, 11, 12, 13, 14, 15, 17. The cycle generally repeats for the duration of the signal. The frames 4, 10, and 16 are generally dropped. Since the signal is in a progressive mode, there is no top/bottom frame issue. Next, the signal is re-interlaced back into the output video signal operating at 25 Hz. By performing the conversions on the progressive frames, motion an blurriness issues are minimized.

While the invention has been particularly shown and described with reference to the preferred embodiments thereof, it will be understood by those skilled in the art that various changes in form and details may be made without departing from the spirit and scope of the invention.

1. An apparatus comprising:
a de-interlacer circuit configured to generate a first progressive signal having a first rate in response to an interlaced signal;
a rate converter circuit configured to generate a second progressive signal having a second rate in response to said first progressive signal; and
a synchronization circuit configured to generate an output video signal synchronized with an output audio signal in response to an input audio signal and said second progressive signal.

2. The apparatus according to claim 1, further comprising:
an interlacing circuit configured to generate said output video signal having an interlaced pattern.

3. The apparatus according to claim 1, wherein said first rate comprises 60 Hz and said second rate comprises 50 Hz.

4. The apparatus according to claim 1, wherein said first progressive signal has a first image size and said second progressive signal has a second image size, wherein said first and second image sizes are different sizes.

5. The apparatus according to claim 4, wherein (i) said first image size comprises a first horizontal size and a first vertical size and (ii) said second image size comprises a second vertical size and a second horizontal size.

6. The apparatus according to claim 1, wherein said rate converter is configured to (i) receive a series of incoming progressive frames with a timestamp, (ii) compare the timestamp value to a clock running at the video output rate, (iii) repeat the previous incoming progressive frame if the input is running early or (iv) drop the incoming progressive frame and output the next incoming progressive frame if the input is running late.

7. The apparatus according to claim 1, further comprising:
a vertical resealing circuit configured to resize said output video signal.

8. The apparatus according to claim 1, further comprising:
an interlacer circuit configured to convert said output video signal to an interlaced signal.

9. The apparatus according to claim 1, wherein said output signal comprises a digital video signal.

10. A method for rate conversion of a digital video signal comprising the steps of:
(A) converting an interlaced video signal to a first progressive video signal having a first rate;
(B) generating a second video signal having a second rate in response to said first video signal; and
(C) synchronizing said second video signal to an input audio signal.

11. The method according to claim 10, wherein said first rate comprises 60 Hz and said second rate comprises 50 Hz.

12. The method according to claim 10, wherein said first progressive signal has a first image size and said second progressive signal has a second image size, wherein said first and second image sizes are different sizes.

13. The method according to claim 12, wherein (i) said first image size comprises a first horizontal size and a first vertical size and (ii) said second image size comprises a second vertical size and a second horizontal size.

14. The method according to claim 10, further comprising the step of:
(D) converting said second video signal to an interlaced signal.

15. The method according to claim 10, further comprising the step of:
resizing said second video signal.
